(19) United States
(12) Patent Application Publication
(10) Pub. No.: US 2008/0270142 A1
(43) Pub. Date: Oct. 30, 2008

(54) Remote Interactive Information Delivery System

(75) Inventors: Ramakrishnan Srinivasan, San Jose, CA (US); Dilip Panicker, Bangalore (IN); Madras Dorai Ramaswami, Bangalore (IN)

Correspondence Address: Ash Tankha, 36, Greenleigh Drive, Sewell, NJ, 08080, US

(73) Assignee: Find 1-4-U Inc.

(21) Appl. No.: 12/108,536

(22) Filed: Apr. 24, 2008

(30) Foreign Application Priority Data
Apr. 25, 2007 (IN) 872/CHE/2007

(51) Int. Cl. G10L 11/00; G06F 17/30

(52) U.S. Cl. 704/270.1; 707/2; 704/E11.001; 704/E15.001; 707/E17.017

(57) ABSTRACT

Disclosed herein is a method and system for providing a response to a user's request for information. The user calls into an intelligent information delivery system requests for the information. The information request is recorded as an audio file at the intelligent information delivery system. A structured text form of the audio file is refined into an optimized search query. The optimized search query is input to retrieve search results comprising information of interest from a data server. The search results are processed into an agent readability enhanced and context specific output and displayed to the agent. The agent selects context specific results from the displayed output. The selected context specific results are formatted to an optimized speech deliverable text form. Content of the optimized speech deliverable text form is converted into a voice stream. The voice stream is then communicated to the user.

### CROSS REFERENCE TO RELATED APPLICATIONS

This application claims the benefit of Indian patent application with number “872/CHE/2007” titled “Remote Interactive Information Delivery System”, filed on “25 Apr., 2007” in the Indian Patent Office.

### BACKGROUND

This invention in general relates to an information delivery system. More particularly, this invention relates to a method and system for providing a response to a request for information from a user.

With increasing choices available in various sectors of commerce, industry, entertainment, and even daily lifestyles, relevant information is necessary to make prudent decisions. A user can perform a world wide web search to obtain the information of interest. However, such a search method implicitly assumes that the user has access to the internet whenever information is required. The accessibility to the internet may not be readily available due to location constraints, the mobility of the user, time constraints on the user or simply the unavailability of a computer with internet access.

To overcome the above problem, centralized information centers were introduced and have now become prevalent. In a typical scenario, the person seeking information, herein referred to as a “caller”, makes a telephone call to a centralized information center and requests a human operator for relevant information. The operator listens to the request, performs a search on the internet and may convey the results to the caller telephonically. In the existing methods, an operator typically performs a keyword search. Relevance of the search result may get affected due to the operator's inexperience and lack of knowledge about the information requested. Also, the operator performing a direct search on the internet using any of the search engines may not yield search results that are specific to the context of the user and that is optimized for voice delivery.

Given today's help desk resources spread across countries, communicating in a non regional language has its own limitation. Such a limitation may affect any method or system that mainly depends on language specific voice communication. In the existing methods, after obtaining the web search results, the operator may have a brief description that is usually the first few lines displayed below every web link in a search engine's result page. The operator may have to interpret the available limited description and construct an oral response to the caller, such that the response satisfies the caller with the necessary information. The operator's communication skill may be one of the factors that decide the caller's satisfaction level.

There is an unmet need for an intelligent information delivery system that stores, organizes and searches world wide web information, using operator assistance at appropriate steps in order to provide a response to a request for information from a caller. There is also a need for the intelligent information delivery system to directly convert the relevant search results into descriptive caller understandable responses and the responses being most suitable for voice delivery.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The method and system disclosed herein addresses and provides solutions to overcome the above mentioned needs for an intelligent information delivery system for storing, organizing, and searching world wide web information, using operator assistance at appropriate steps in order to providing a response to a request for information from a user.

The user calls the intelligent information delivery system requesting for the information. The information request is recorded as an audio file at the intelligent information delivery system. The audio file is processed by utilizing the intelligent information delivery system. The audio file is played and transcribed into a structured text form. The structured text form of the audio file is refined into an optimized search query. The refinement of the structured text form comprises obtaining correct spelling and synonyms of keywords and grouping of the synonyms to form phrases specific to context of the information request of the user. The refinement of the structured text form further comprises employing context specific prompts to provide the optimized search query. The refinement of the structured text form further comprises an auto complete logic for automatically listing out words based on the first few letters typed by the agent. The employment of the context specific prompts comprises storing the context specific prompts in an information database and constantly updating the context specific prompts.

The optimized search query is input to retrieve search results comprising information of interest from a data server. The search results are processed into an agent readability enhanced and context specific output. The processing of the search results comprises an intelligent automated selection of text portions specific to context of the information request of the user. The processing of the search results further comprises an intelligent automated sequencing of the selected text portions in decreasing order of relevance specific to the context of the information request of the user. The agent readability enhanced and context specific output is displayed to the agent. The agent selects context specific results from the displayed output. The agent ranks the selected context specific results.

The ranked context specific results are formatted to an optimized speech deliverable text form. The formatting of the ranked context specific results comprises converting the context specific results to the optimized speech deliverable text form by performing translations, forming complete sentences, and adding speech elements using a markup language. The intelligent information delivery system converts content of the optimized speech deliverable text form to a voice stream. The voice stream is then communicated to the user.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of processing the request for information from a user and providing the information of interest to the user.

FIG. 2 illustrates a method of obtaining a satisfactory search result in an optimized speech deliverable text form from an agent typed query.

FIG. 3 illustrates a method of obtaining context specific results in an agent readability enhanced form from an optimized search query.

FIG. 4A illustrates a system for providing a response to an information request from a user by an agent, wherein the agent has access to an intelligent information delivery system through a network.

FIG. 4B illustrates an embodiment of the system for providing a response to an information request from a user by an agent, wherein the agent has direct access to the intelligent information delivery system.

FIG. 5 exemplarily illustrates tags used in speech synthesis markup language message format and the voice extensible markup language for presenting the search results.

FIG. 6 illustrates a screenshot of the search result display along with the refinements applied to the search query, the available standard prompts, the generated context specific prompts, and the ranking of the search results.

### DETAILED DESCRIPTION OF THE INVENTION

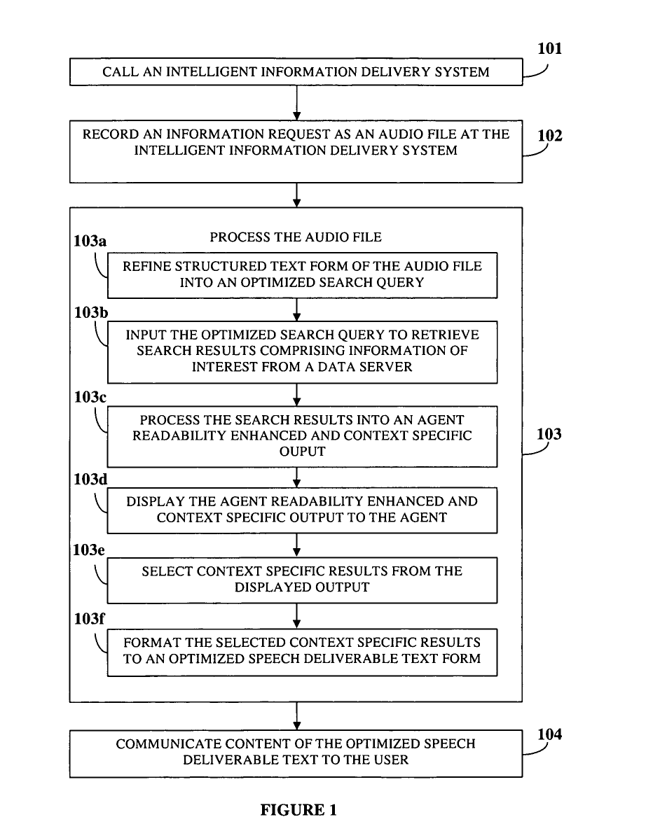

FIG. 1 illustrates a method of processing the request for information from a user 400 and providing the information of interest to the user 400. The user 400 calls 101 an intelligent information delivery system (IIDS) 402 and makes a request for information. The user 400 may use a telephone 406 to make the call. The telephone used by the user 400 may be a landline based telephone, a mobile phone, an internet phone, etc. An agent 403 processes the request of the user 400 with the assistance of the IIDS 402. The user 400 and the agent 403 may be remotely located. The user 400 and the agent 403 may be connected to the IIDS 402 via a network 401.

The IIDS 402 maintains and manages a voice connection with the user 400. The voice connection enables the user 400 to make the information request. At all times, an uninterrupted conversation between the user 400 and the agent 403 is ensured by employing standard voice prompts, generated by the IIDS 402. The standard voice prompts could be a series of general questions or remarks employed to engage the user 400 in a conversation. For example, the general questions or remarks may be: “How may I assist you?”, “Can you please spell that?” etc.

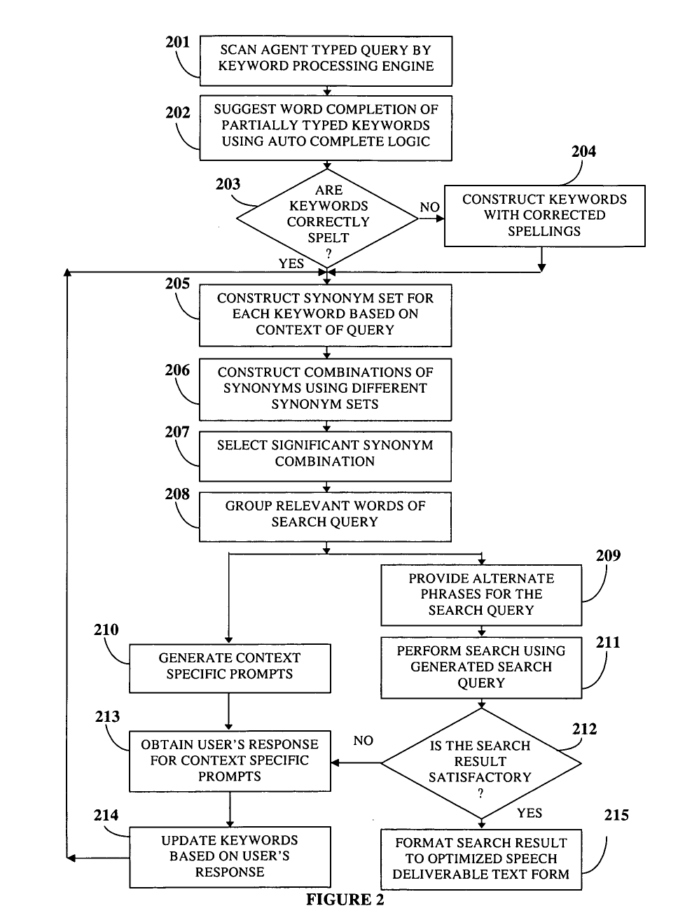

The voice request of the user 400 is recorded 102 as an audio file and stored in an information database 402a. The agent 403 plays the recorded audio file and the audio content in the audio file is transcribed into a structured text form. The transcription of the audio file into the structured text form may be performed manually by the agent 403 while listening to the playback of the audio. The transcription of the audio file into the structured text form may also be performed automatically using methods of speech to text conversion. The audio file is processed 103 by utilizing the IIDS 402. The structured text form of the audio file is refined 103a into an optimized search query. The refining of the structured text form comprises obtaining correct spelling and synonyms of keywords, grouping of the synonyms to form phrases specific to context of the information request of the user 400. The structured text form is converted to the optimized search query by deriving keywords, grouping keywords, generating synonym sets, and combining synonyms of different synonym sets. The search query is further optimized by employing context specific prompts prompted by the IIDS 402. The context specific prompts are stored in an information database 402a and the context specific prompts are constantly updated. An auto complete logic automatically lists out words based on a first few letters typed by the agent 403. The agent 403 may select a word from the listed words. The method of converting the structured text form into the optimized search query is explained in the detailed description of FIG. 2.

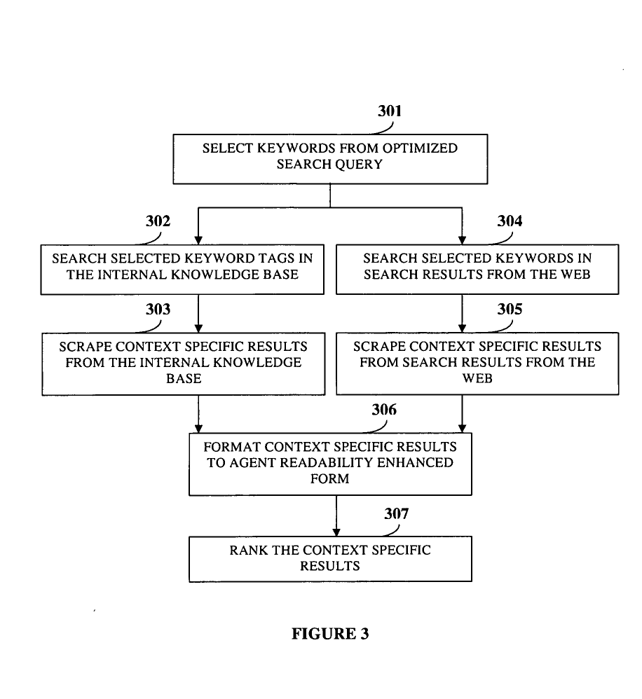

The optimized search query is input 103b to a search engine to retrieve search results from a data server 404 that may be an internal knowledge base (IKB), the internet, or a combination thereof. The IIDS 402 processes 103c the retrieved search results to obtain an agent readability enhanced and context specific output. From the retrieved search results, the IIDS 402 scrapes potential answers using a scraping algorithm. The IIDS 402 further performs intelligent automated selection of text portions from the search results. The selected text portions are specific to context of the information request of the user 400. The IIDS 402 further performs an intelligent automated sequencing of the selected text portions in decreasing order of relevance specific to the context of the information request of the user 400. Based on the intelligence and learning acquired by the IIDS 402 from processing requests of users over a period of time, the IIDS 402 extracts text portions from the search results that are specific to the context of the request. The method of obtaining context specific results in an agent readability enhanced form from an optimized search query is exemplarily illustrated in FIG. 3.

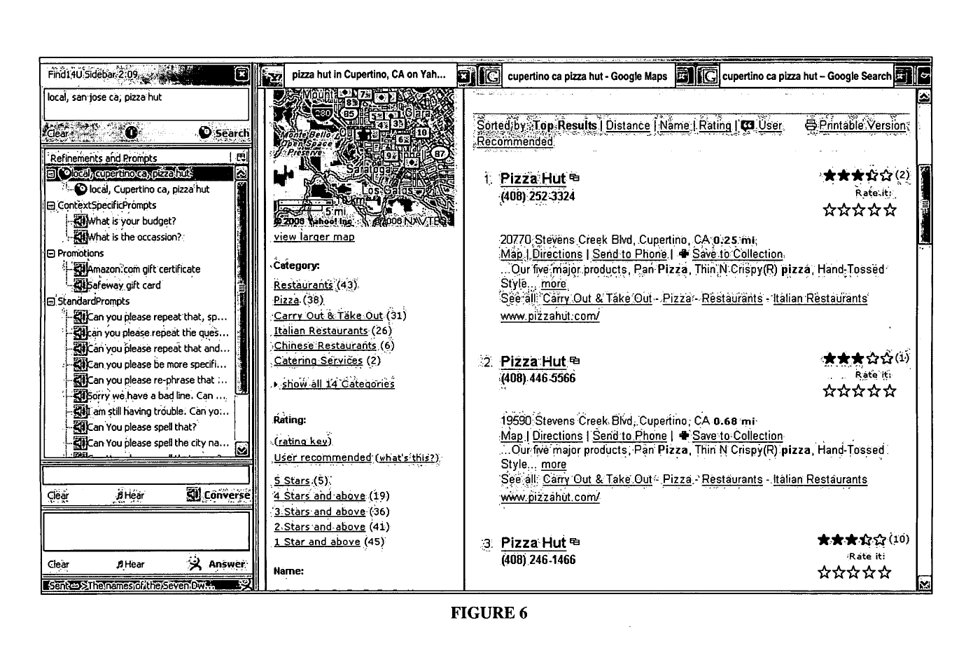

The agent readability enhanced and context specific output is displayed 103d to the agent 403. To illustrate the processing and display of agent readability enhanced and context specific output, consider the example of an information request for pizza eateries in Cupertino, Calif. Upon transcription of the unstructured information request such as “Where can I get pizza in Cupertino?”, the agent 403 may restructure the information request, for example “local, Cupertino, Calif., pizza”, as the initial search query. In order to further optimize the search query, the IIDS 402 may generate context specific prompts that the agent 403 may use, for example, “Would you prefer a nearer location or a better facility?”. From the obtained search results, text portions including the name of the pizza eatery, the telephone number, the address of the eatery, and the special dishes of the eatery may be extracted by the IIDS 402. According to the relevance of the context of the request made by the user 400, the extracted text portions may be organized as the name of the eatery, the telephone number, and the address of the eatery, in that order. Hyperlinks to map directions to the eatery or to place an online order for a pizza may be provided. Furthermore, additional information such as popular ratings of the eatery, eateries in Cupertino recommended by other users, etc., may also be provided. The agent readability enhanced and context specific output, in the above illustration, containing the information of pizza eateries are displayed on the computer terminal 405 of the agent 403, as illustrated in the screenshot in FIG. 6. The screenshot illustrates an itemized list of options displayed, allowing (a) filtering with various criteria, and (b) customized display of deliverable attributes. A list of standard prompts and the context specific prompts used may also be displayed in one section of the display, as illustrated in FIG. 6.

The agent 403 selects 103e context specific results from the displayed output. The agent 403 ranks the context specific results using the IIDS 402, and selects the results relevant to the information of interest. The ranking of the search results may be based on the ratings of previous users with similar requests. The ranking may also be based on personal judgment of the agent 403. The request history of previous users is stored in the information database 402a, and contains search result ratings of the previous users along with the information request made by the previous users, the optimized search queries, and the relevant search results. When the agent 403 obtains context specific results based on a new information request, the IIDS 402 selects search result ratings of previous users with similar requests from the request history and provides a ranking for the newly obtained search results. The ranking method assisted by the intelligence and learning of the IIDS 402 enables the agent 403 to select search results that provide information pertinent to the context of the information request.

The IIDS 402 formats 103f the selected context specific results into an optimized speech deliverable text form. The selected context specific results are converted to the optimized speech deliverable text form by performing translations, forming complete sentences, and adding speech elements using a markup language. The agent 403 may manually format the selected context specific results into an optimized speech deliverable text form. The speech delivery may be performed directly by the agent 403 or through the voice stream synthesized in the IIDS 402. In both forms of speech delivery, there are common steps involved in converting the context specific results to answers that may be interpreted by the user 400. Firstly, the agent 403 constructs parts of the answer from the selected search results, specific to the context of the information request. The IIDS 402 refines the selected search result by performing translations and completing sentences, such that the constructed answer is understandable in an independent voice context. The IIDS 402 may exemplarily use a language engine for performing the step of refinement. The results may be shown to the agent 403. The agent 403 may then choose to edit the results, based on personal judgment. If the agent 403 chooses to edit an automatically generated string, both the suggested and corrected strings are stored in the information database 402a for reinforcement learning by the IIDS 402. If the speech delivery is performed by the agent 403, the agent 403 may directly read out the completely constructed answer to the user 400.

If the speech delivery is in the form of a synthesized voice stream, the completely constructed answer that is in text form is marked with additional attributes, such as speech synthesis markup language (SSML) tags or voice extensible markup language (VXML) tags. The tags ensure that the sentences, in the completely constructed answer, include machine understandable diction elements, such as breaks, pauses, emphasis, etc. Such marking with additional attributes, renders the text form of answers as a suitable input for automated speech synthesis. The marking up of completely constructed answer with tags may be performed by the IIDS 402 or by the agent 403.

To illustrate the formatting of a selected context specific result to an optimized speech deliverable text form, consider the following example. The user 400 may want to know the weather condition of a particular place on a particular day. The information request made by the user 400 may be, “What is the weather like, in Cupertino tomorrow?” The agent 403, using the IIDS 402, refines the request into an optimized search query as, ‘weather, Cupertino Calif., Thursday’. The agent readability enhanced and context specific output of the selected search result may be displayed as, ‘Thu Hi 55 F Lo 42 F 80% chance of precipitation’. To construct an answer, the phrase ‘Forecast for tomorrow, Thursday is’ may be inserted, by the IIDS 402 based on the query context, or by the agent 403, in the beginning of the text. The search result may be processed by the agent 403 and interpreted into text as, ‘high of 55 and a low of 42 degrees Fahrenheit. There is 80% chance of rain’. The processed search result is suffixed to the previously inserted phrase. The resulting sentence is synthesized into speech and delivered to the user 400; or, the agent 403 may read out the completely constructed answer, directly to the user 400.

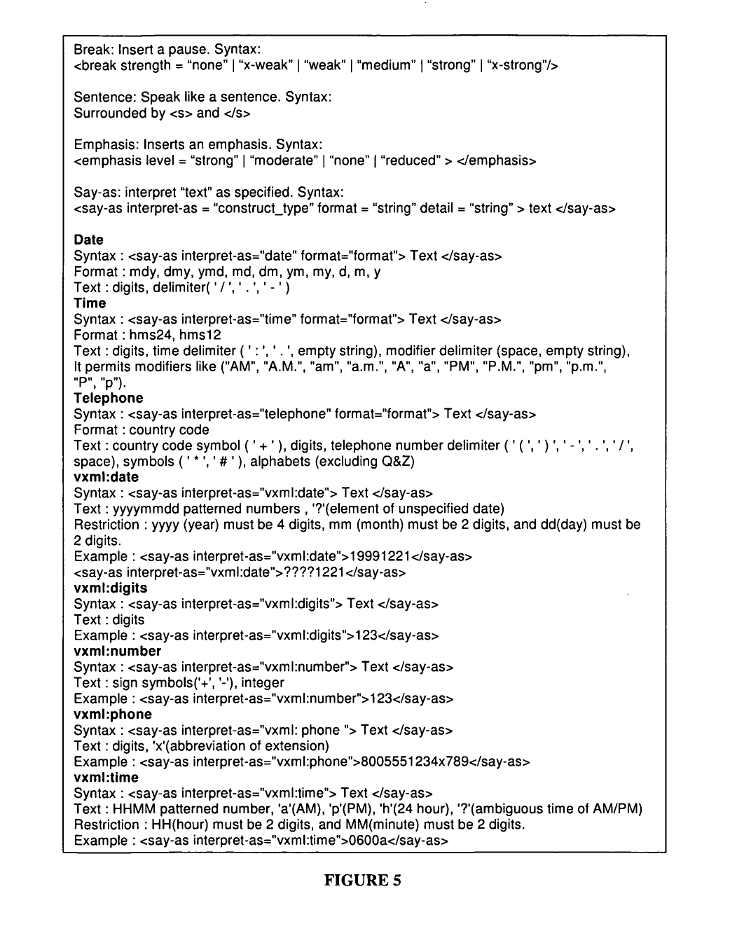

If the completely constructed answer has to be provided to the IIDS 402 for automated speech delivery, additional machine understandable diction attributes may be inserted in the text. Diction attributes such as emphasis on the numbers, a pause between the phrases ‘for tomorrow’ and ‘Thursday is’, or a break in the speech between the phrases ‘Thursday is’ and ‘high of 55’ may be introduced by inserting SSML tags or VXML tags. The SSML tags and VXML tags for machine understandable diction attributes are exemplarily illustrated in FIG. 5. The optimized speech deliverable text comprising the completely constructed answer and the associated tags, are provided to the IIDS 402. The IIDS 402 converts content of the optimized speech deliverable text form to a voice stream. The IIDS 402 communicates 104 the voice stream to the user 400.

FIG. 2 illustrates a method of obtaining a satisfactory search result in an optimized speech deliverable text form from an agent typed query. The automatically generated transcription of the information request in structured text form along with the raw audio format of the information request may be available to the agent 403. From the transcription, keywords or data items are extracted either manually by the agent 403 or dynamically by a keyword processing engine 402g embedded into the IIDS 402. As the agent 403 types a search query, the keyword processing engine 402g scans 201 and compares the typed search query with the list of keywords existing in the information database 402a. Using embedded auto complete logic, the keyword processing engine 402g suggests 202 possible word completions for partially typed keywords. Such an automated word completion feature minimizes the errors due to incorrect word spellings. New keywords occurring in search queries and absent in the information database 402a, are included into the existing list of keywords and stored in the information database 402a.

The agent 403 separates the keywords from each other using delimiters such as comma, semi colon, colon, etc. The keyword processing engine 402g checks 203 the separated keywords for correctness of word spellings. If the keywords are incorrectly spelt, the IIDS 402 constructs 204 the incorrectly spelt keyword with correctly spelt keyword. For example, for the name of a place with incorrect spelling such as “cuprtno”, the keyword processing engine 402g may suggest the correct spelling and duly replace “cuprtno” with “Cupertino”.

For every keyword generated, the IIDS 402 constructs 205 a set of synonyms relevant to the context of the query. For example, a synonym set for a train station could have “railway station” and “metro station” as synonyms. The IIDS 402 further constructs 206 various combinations of synonyms, derived from the synonym sets of different keywords. Out of all the possible combinations of synonyms, the IIDS 402 selects 207 a combination significant to the context of the request made by the user 400. Based on the context of the information request, certain keywords in the significant combination may be grouped 208. The significant synonym combination may be directly used as a search query or may be used to provide 209 alternate phrases for the search query. The alternate phrasing may be performed to increase the search efficiency. The synonym sets for keywords, the combination synonym sets, and the alternate phrases are stored in the information database 402a and constantly updated with every new request for information from different users. From the significant synonym combination, the IIDS 402 simultaneously generates 210 context specific prompts that may be used for further optimization of the search query. Context specific prompts are used to narrow down a broader request to focus on obtaining specific information. The IIDS 402 generates context specific prompts based on the intelligent learning of the IIDS 402 that takes place through understanding of requests from users over a period of time. The generation of context specific prompts is keyword driven, and is triggered by the presence and proximity of the keywords or data items. For example a search query on gifts without numbers in the query may trigger the IIDS 402 to generate the context specific prompt, “What is your budget?”

The agent 403 performs a search 211 using the generated search query and obtains the search results. However, the agent 403 or the user 400 determines 212 if the information obtained from the search results is satisfactory. If the search results are unspecific or unsatisfactory, the agent 403 obtains 213 response of the user 400 to the IIDS 402 generated context specific prompts. The agent 403 updates 214 the keywords based on the response of the user 400 and a new significant synonym combination is generated. If the search results are satisfactory the search results are formatted 215 to optimized speech deliverable text form. The newly generated synonym combination, serving as an optimized search query, is used to obtain new context specific results. Such newly generated optimized search queries are stored in the information database 402a and the IIDS 402 may reuse the optimized search queries while processing the information request similar in context.

Consider the following examples that illustrate context specific prompts. A search query for a pizza eatery may be in the form, ‘local, Cupertino, pizza hut’. To overcome the ambiguity of which Cupertino is being referred to, the context specific prompt generated could be, “Is that Cupertino in California?” Another request could be for buying gifts for a person. The query could be phrased as, “Valentine day gifts, grandmother”. To narrow down on the cost of the gift, the context specific prompt could be, “What is your budget?”

The selected context specific results may be used to obtain a completely constructed answer and further formatted into an optimized speech deliverable text form that can be communicated to the user 400.

FIG. 3 illustrates a method of obtaining context specific results in an agent readability enhanced form from an optimized search query. The IIDS 402 processes the selected search results to obtain an agent readability enhanced and context specific output. From the selected search results the IIDS 402 scrapes potential answers using a scraping algorithm. The scraping algorithm deduces scrape areas based on (a) the keywords used in the optimized search query and (b) information of the search result provider. The IIDS 402 selects 301 the keywords from the optimized search query and searches 302 for the tags of corresponding keywords in the IKB. IKB organizes and stores information in a flexible manner, for example, as in an XML format, with an opening and ending tag, such as <keyword> and </keyword>. Tags may also be hierarchically nested.

The information stored between the starting and ending tags of a particular keyword is extracted from the IKB to create scrapes 303 of information for that keyword. The IIDS 402 further searches 304 for the selected keywords in the search results obtained from the web and scraped 305 context specific results. The context specific results from the IKB and the web are combined and formatted into an agent readability enhanced and context specific output.

Consider an example of an optimized search query as: ‘hours, san jose ca, children's discovery museum’. The IIDS 402 selects the keywords ‘hours’, ‘san jose, Calif.’, ‘museum’, ‘discovery’ and ‘children’. The IIDS 402 searches for the tags <hours> and </hours> in the IKB. The information included between the two tags is scraped from the IKB. If IKB does not contain <city> san jose </city><state>ca</state><amenity> children's discovery museum </amenity>, then the <hours> tag will not be returned from the IKB to the IIDS 402 and search results from alternate search providers from the Internet will be used. The alternate search providers may be a search engines like Google® or Yahoo™. The search results may be provided from a single search engine or a combination of many search engines. The IIDS 402 searches for the keyword “Hours:” in the search results from the Internet and scrapes information present after the keyword “Hours:” till the end of the line where “Hours:” is occurring.

Consider another example of a weather search query: weather, santa cruz Calif., weekend. AccuWeather™ may be a more appropriate and specific search engine for the above query. The IIDS 402 searches for tags “<div class=“dateDetails”>Saturday” followed by “<div class=“dateConditions”>” and scrapes text till “</div>”; and again searches for “<div class=“dateWeatherText”>” and scrapes text till “</div>”. The search process is repeated for “<div class=“dateDetails”>Sunday,” and <div class=“dateDetails”>Sunday Night,” and the answers are aggregated.

The scrape answers obtained by the IKB and the alternate search providers are formatted 306 by format logic specifically defined, with respect to the keyword and the search result provider. Consider the previous example of search query for a museum: ‘hours, san jose Calif., children's discovery museum’. The search result may be extracted from the IKB. The results may be provided in an agent deliverable format as free text. The search results may appear as: “The children's discovery museum in San Jose, Calif. is open from Tuesday to Saturday 10 AM to 5 PM and on Sundays 12 noon to 5 PM”. If the search results are provided from the Internet by the search engines, a sentence is constructed using the search query. The formatted sentence created using the query will be: The <children's discovery museum> in <San Jose, Calif.> is open <Tuesday to Saturday 10 AM to 5 PM> and on <Sundays 12 noon to 5 PM>. The first 2 keyword fields are filled in from the optimized search query, whereas the last two may be expanded from the Internet scraped information specific to hours. In case of the example related to weather search query, the search results may be provided by AccuWeather, and the search results may appear on the computer terminal 405 as:

### Saturday March 17: High: 74° F. RealFeel®: 81° F.

Mostly sunny and warm; areas of morning fog, then pleasant this afternoon

### Friday Night, March 16: Low: 47° F. RealFeel®: 53° F.

Clear to partly cloudy

### Sunday March 18: High: 67° F. RealFeel®: 69° F.

Low clouds and fog giving way to sun

### Sunday Night: Low: 48° F. RealFeel®: 50° F.

Partly cloudy.

The sentences may be refined using the keywords of the input optimized search query and the resulting text may be: Here is the forecast for this weekend for your location Santa Cruz, Calif. Saturday will have a high of 74 degrees and a low of 47 degrees Fahrenheit. The day will be mostly sunny and warm; areas of morning fog, then pleasant this afternoon. The night will be clear to partly cloudy. Sunday will have a high of 67 degrees and a low of 48 degrees. The day will be low clouds and fog giving way to sun. The night will be partly cloudy.

The formatted results are then ranked 307 using the IIDS 402. The IIDS 402 uses a formatted result ranking mechanism to rank the results. The formatted result ranking mechanism has two components.

The first component is an automated ranking logic based on previous successful searches delivered by agents. As an example, if 70% of the formatted results from previous search queries are drawn from AccuWeather.com, 20% are drawn from Wunderground.com and 10% from Weather.com, then results of AccuWeather.com would be ranked first, results of Wunderground.com would be ranked second and results of Weather.com would be ranked last. If no ranking is available at all, the agent 403 may pick the best result from the formatted results presented in multiple result boxes on the computer terminal 405. A new entry in the IKB may be created and may be used in the future to auto rank similar search results.

The second component uses agent intelligence to choose the best possible result from the formatted result set presented in multiple result boxes. The agent 403 can make changes to the auto formatted text so as to improve the results for optimal speech delivery by a speech synthesizer 402d. In the weather example above, from the formatted the agent 403 may recognize that “The day will be low clouds and fog giving way to sun” is not an optimal construct and may change the sentence to: “The day will have low clouds and fog giving way to sun”. When the result is delivered, the IKB is updated to increase the ranking of the corresponding keyword and the search result provider entry.

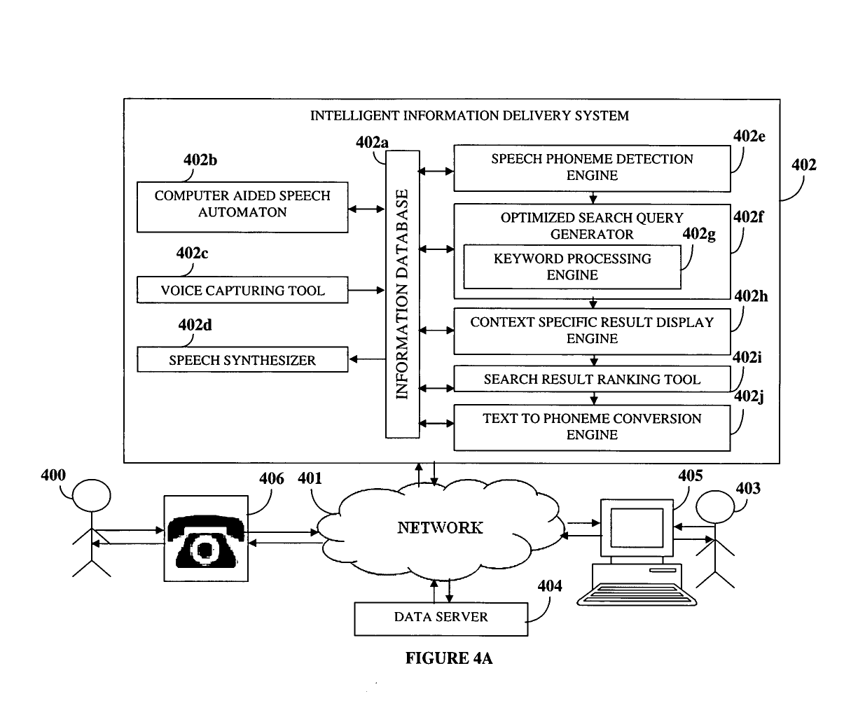

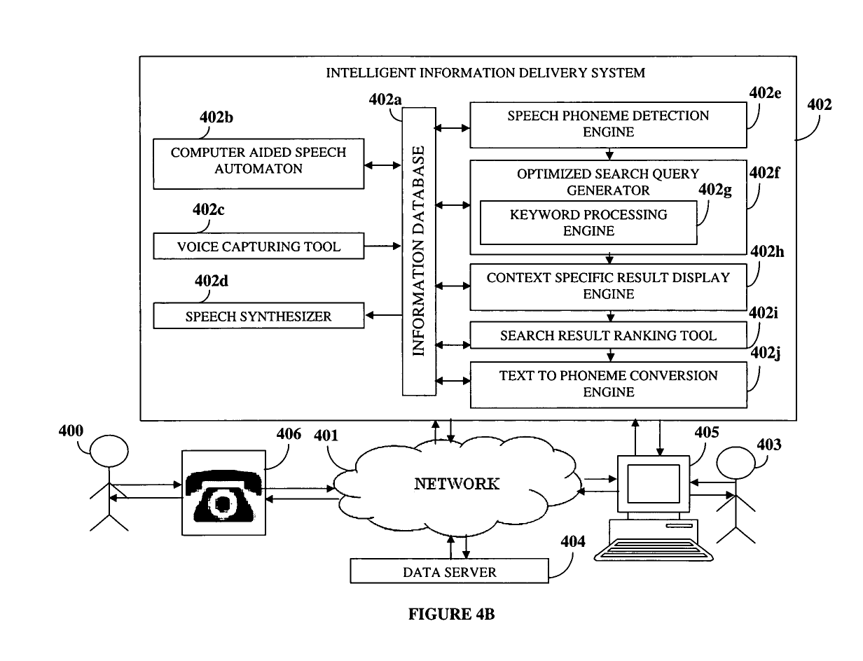

FIG. 4A illustrates a system for providing a response to an information request obtained from a user 400 by an agent 403 via a network 401. The user 400 uses a telephone 406 to make a voice request for information of interest. The telephone 406 may be a landline based telephone, a mobile phone, or an internet phone. An intelligent information delivery system (IIDS) 402 acts as the interface between the user 400 and an agent 403 via a network 401. The agent 403 communicates with the user 400 and IIDS 402 through a computer terminal 405 that is connected to the network 401. The IIDS 402 processes the information request of the user 400 and provides an interface between the user 400 and the agent 403.

The IIDS 402 comprises an information database 402a, a computer aided speech automaton 402b, a voice capturing tool 402c, and a speech synthesizer 402d as the modules providing the interface with the user 400. The voice request from the user 400, received through the telephone 406, is captured by the voice capturing tool 402c. The voice capturing tool 402c records the information request as an audio file and stores the audio file in the information database 402a. A voice connection is established between the user 400 and the IIDS 402. The voice connection enables the user 400 to make the information request. The voice connection with the user 400 is managed by the computer aided speech automaton 402b. The computer aided speech automaton 402b generates voice prompts to maintain the voice connection between the IIDS 402 and the user 400. The computer aided speech automaton 402b accesses the standard prompts stored in the information database 402a and transmits the prompts to the user 400 at regular intervals. The computer aided speech automaton 402b ensures that the conversation with the user 400 is kept alive until the call gets disconnected.

The modules of IIDS 402 responsible for processing the information request comprises a speech phoneme detection engine 402e, an optimized search query generator (OSQG) 402f, a context specific result display engine (CSRDE) 402h, a search result ranking tool (SRRT) 402i, and a text to phoneme conversion engine 402j. The information request processing modules may independently access the information database 402a.

For further processing, the agent 403 may access the audio file stored in the commonly shared information database 402a. The audio file is transcribed into a structured text form and stored as a text file in the information database 402a. The structured text form is a structured transcription of the audio file. The structured text form may be manually generated by the agent 403 by playing the audio file and listening to the audio content in the audio file. The structured text form may also be generated automatically by the speech phoneme detection engine 402e. The speech phoneme detection engine 402e may automatically convert the audio file into a structured text form. The OSQG 402f generates an optimized search query from the structured text form of the audio file. The OSQG 402f is a programmed tool for dynamically loading valid keywords for retrieving the search results. The OSQG 402f comprises a keyword processing engine 402g and incorporates auto complete logic.

The IIDS 402 further performs intelligent automated selection of text portions from the search results. The selected text portions are specific to context of the information request of the user 400. The IIDS 402 further performs an intelligent automated sequencing of the selected text portions in decreasing order of relevance specific to the context of the information request of the user 400. Based on the intelligence and learning acquired by the IIDS 402, the keyword processing engine 402g generates keywords with correct word spellings. The OSQG 402f, using such keywords constructs a significant combination of synonyms of different keywords to be used in the search query. If the search query yields unsatisfactory search results, the OSQG 402f may further optimize the search query by generating context specific prompts. The optimized search query is used as an input to a search engine to retrieve context specific results from a data server 404 that may be an internal knowledge base (IKB) or the Internet. With every new optimized search query, hitherto absent in the IKB, the OSQG 402f constantly updates the IKB with the new optimized search queries, thereby enabling an intelligent learning of the IIDS 402.

OSQG 402f comprises the following components or implementations: (a) a keyword driven syntax and its generation, (b) context specific auto complete logic and its implementation, and (c) query refinement engine and its implementation.

The OSQG 402f transcribes the audio file into a structured text form. The transcription is accomplished with the following steps: (a) speech phoneme detection engine 402e recognizes specific keywords from the information request in audio format; (b) the keyword recognition is supervised and corrected by the agent 403; (c) the corrections to the keywords are stored along with the raw audio form in the internal knowledge base (IKB); (d) the stored keyword information in the IKB is used to train the speech phoneme detection engine 402e. The speech phoneme detection engine 402e converts the information request in voice format into a set of keywords.

Consider the following examples that illustrate the transcription of the information request in voice format:

### EXAMPLE 1

If the audio query input is: What time does children's discovery museum in San Jose open tomorrow?

The speech phoneme detection engine 402e may recognize the keywords: time, San Jose, children's discovery museum, and tomorrow. The agent 403 may replace the keywords ‘time, San Jose, and tomorrow’ with ‘hours, San Jose Calif., and Thursday 25’, respectively, thereby making the search query context specific.

### EXAMPLE 2

If the audio query input is: What is the forecast for Santa Cruz this weekend?

The speech phoneme detection engine 402e may recognize the keywords: Santa Cruz, weekend. The keyword ‘forecast’ may not be stored in the IKB and hence not recognized the speech detection phoneme engine 402e. The agent 403 may recognize the keyword ‘forecast’ in the audio query and duly add the keyword ‘weather’ in the search query. The keyword ‘weather’ is stored in the IKB for training the speech phoneme detection engine 402e for later recognition and usage in other request instances.

The generated syntax may be: ‘weather, Santa Cruz Calif., Saturday 27, Sunday 28’.

### EXAMPLE 3

If the audio query input is: How do I go from Cupertino to Sunnyvale?

The generated syntax may be: ‘drive, Cupertino ca, Sunnyvale Calif.’.

### EXAMPLE 4

If the audio query input is: What is the closest pizza place to Monterey bay aquarium and how do I get there?

The generated syntax may be: ‘nearest/drive, Monterey Calif., Monterey bay aquarium, pizza’.

In Example 4, a compounded keyword such as ‘nearest/drive’ that is a combination of two key words is used.

The auto complete logic is used assist the agent 403 for automatically completing keywords spellings. A keyword that is incompletely typed or not understood by the agent 403 can be completed or made understandable to the agent 403 by employing the auto complete logic. The auto complete logic consists of the following components:

(a) a list of known keyword tokens in the IKB, (b) a table look up that matches agent's input to generate a candidate fill, (c) presenting the candidate fill to the agent 403 and managing its acceptance or rejection by the agent 403, and (d) in case, the agent 403 input is not recognized, inserting the agent's new keyword input into the IKB for subsequent auto complete use.

For example, if the input keywords form the speech phoneme detection engine 402e is: ‘near, San J’, then the auto complete logic may intelligently prompt the agent 403 to change the keyword to ‘near, San Jose Calif.’. Using the auto complete logic, the OSQG 402f navigates through the keyword tokens present in the IKB to identify the incomplete keyword ‘San J’ and may suggest ‘San Jose’ for the agent 403 to accept or reject. The agent 403 may include another keyword ‘bernal family dentistry’ and generate the search query ‘near, San Jose Calif., bernal family dentistry’. If the keyword tokens corresponding to ‘bernal family dentistry’ are absent in the IKB, the agent 403 may be prompted to include ‘bernal family dentistry’ into the IKB for later auto complete use.

OSQG 402f may employ a query refinement engine for further (a) generating alternate queries, and (b) generating context specific, meaningful disambiguous questions. Alternate queries and context specific, meaningful disambiguous questions are used to generate the optimized search query. Generation of alternate queries uses the following methods: (a) using databases of synonyms, homonyms, spell check, and word groupings of past successful query refinements stored in the IKB to generate alternate suggestions, (b) monitoring agent 403 query selection, and (c) storing a successful alternate query selection in the IKB for future utilization. The information database 402a comprises a dynamic table comprising synonyms, grouped words, phraseology, voice prompts, and context specific prompts.

For example, if the input query is: “streets, newtown Pa., railway station”, then the IIDS 402 may create synonyms for the word railway, such as ‘train’ and ‘metro’ and store alternate queries in the IKB. The successful alternate query may be ‘streets, newtown pa, train station’. The steps for generation of disambiguous questions are as follows: (a) using the keywords stored in IKB for generating possible disambiguous questions (b) monitoring the agent's keyword input and (c) if the agent's keyword input does not exist in the IKB, inserting the agent's keyword input along with the keywords in the original query as the index.

Consider an input example of: “streets, san jose ca, walgreens”. The query refinement engine may prompt the agent 403 with “We found many walgreens in san jose. Are you looking for one near a certain location, or in a certain street?” Another example of the input may be ‘near/good, san jose ca, ebay, Indian restaurants’, the query refinement engine prompt with “We found many good Indian restaurants in san jose near ebay. There is candidate 1 0.2 miles away with a 4 star rating and there is candidate 2, 2.3 miles away with a 5 star rating. Which one do you want more information on?”.

The CSRDE 402h retrieves search results from a data server 404 based on the optimized search query. The CSRDE 402h displays the search results as an agent readability enhanced and context specific output. The CSRDE 402h provides easy navigability and better comprehension of the displayed search results by the agent 403. The CSRDE 402h extracts text portions from search results that are context specific. Various sections of the extracted text are arranged according to the sections' order of importance as decided by the CSRDE 402h and displayed to the agent 403. The CSRDE 402h may enable hyperlinks on some sections of the extracted text, thereby providing access to further details on the information of interest. The CSRDE 402h also enables the display of standard and context specific prompts along with the search results.

The agent 403 ranks and selects the context specific results using the SRRT 402i. When the agent 403 performs a search based on an information request by the user 400 and obtains context specific results, the SRRT 402i provides the agent 403 with rankings of the search result based on the request history of users with similar requests. The selected context specific results are converted into a completely constructed user understandable answer by the agent 403. If the information needs to be conveyed to the user 400 through a synthesized voice stream, the text to phoneme conversion engine 402j may be employed. The text to phoneme conversion engine 402j formats the selected context specific results to an optimized speech deliverable text form. The text to phoneme conversion engine 402j inserts diction elements, in the form of SSML or VXML tags, to the completely constructed answer in the optimized speech deliverable text form. Such an optimized speech deliverable text form may be stored on the information database 402a. Additionally the completely constructed answer may be transmitted to the user 400 as an optional text message.

The content of the optimized speech deliverable text form is converted into a voice stream by a speech synthesizer 402d and communicated as a voice response from the IIDS 402 to the user 400.

FIG. 4B illustrates an embodiment of the system for providing a response to an information request from a user 400 by an agent 403, wherein the agent 403 has direct access to the IIDS 402. The agent 403 accesses the IIDS 402 through the computer terminal 405.

FIG. 5 exemplarily illustrates tags used in SSML format and VXML format for presenting the search results. VXML defines voice segments and enables access to the internet via telephones and other voice-activated devices. VXML tags instruct voice browsers to provide speech synthesis, automatic speech recognition, dialog management, and audio playback. SSML is part of a larger set of markup specifications for voice browsers. SSML is designed to provide a rich, extensible markup language based on XML format for assisting the generation of synthetic speech on web based and other applications.

FIG. 6 illustrates a screenshot of the search result display along with the refinements applied to the search query, the available standard prompts, the generated context specific prompts, and the ranking of the search results. The screenshot displays a host website with an information database window containing standard voice prompts, context specific prompts, and searched results. The user 400 calls an agent 403 asking for the location of pizza hut in Cupertino, Calif. The conversation between the user 400 and the agent 403 is maintained by selecting appropriate standard prompts from information database window. An optimized search query is constructed by using context specific prompts which are listed out in information database window. The optimized search query is entered in the search text box and the search results are listed out. The agent 403 selects a search result from the list relevant to the information request of the user 400.

It will be readily apparent that the various methods and algorithms described herein may be implemented in a computer readable medium, e.g., appropriately programmed for general purpose computers and computing devices. Typically a processor, for e.g., one or more microprocessors will receive instructions from a memory or like device, and execute those instructions, thereby performing one or more processes defined by those instructions. Further, programs that implement such methods and algorithms may be stored and transmitted using a variety of media, for e.g., computer readable media in a number of manners. In one embodiment, hard-wired circuitry or custom hardware may be used in place of, or in combination with, software instructions for implementation of the processes of various embodiments. Thus, embodiments are not limited to any specific combination of hardware and software. A “processor” means any one or more microprocessors, Central Processing Unit (CPU) devices, computing devices, microcontrollers, digital signal processors, or like devices. The term “computer-readable medium” refers to any medium that participates in providing data, for example instructions that may be read by a computer, a processor or a like device. Such a medium may take many forms, including but not limited to, non-volatile media, volatile media, and transmission media. Non-volatile media include, for example, optical or magnetic disks and other persistent memory volatile media include Dynamic Random Access Memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during Radio Frequency (RF) and Infrared (IR) data communications. Common forms of computer-readable media include, for example, a floppy disk, a flexible disk, hard disk, magnetic tape, any other magnetic medium, a Compact Disc-Read Only Memory (CD-ROM), Digital Versatile Disc (DVD), any other optical medium, punch cards, paper tape, any other physical medium with patterns of holes, a Random Access Memory (RAM), a Programmable Read Only Memory (PROM), an Erasable Programmable Read Only Memory (EPROM), an Electrically Erasable Programmable Read Only Memory (EEPROM), a flash memory, any other memory chip or cartridge, a carrier wave as described hereinafter, or any other medium from which a computer can read. In general, the computer-readable programs may be implemented in any programming language. Some examples of languages that can be used include C, C++, C#, JAVA, TCL/TK, PERL, PHP or Python. The software programs may be stored on or in one or more mediums as an object code. A computer program product comprising computer executable instructions embodied in a computer-readable medium comprises computer parsable codes for the implementation of the processes of various embodiments.

Where databases are described, such as the information database 402a, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats including relational databases, object-based models and/or distributed databases could be used to store and manipulate the data types described herein. Likewise, object methods or behaviors of a database can be used to implement various processes, such as the described herein. In addition, the databases may, in a known manner, be stored locally or remotely from a device that accesses data in such a database.

The present invention can be configured to work in a network environment including a computer that is in communication, via a communications network, with one or more devices. The computer may communicate with the devices directly or indirectly, via a wired or wireless medium such as the Internet, Local Area Network (LAN), Wide Area Network (WAN) or Ethernet, Token Ring, or via any appropriate communications means or combination of communications means. Each of the devices may comprise computers, such as those based on the Intel® processors, AMD® processors, Sun® processors, IBM® processors etc., that are adapted to communicate with the computer. Any number and type of machines may be in communication with the computer.

The foregoing examples have been provided merely for the purpose of explanation and are in no way to be construed as limiting of the present method and system disclosed herein. While the invention has been described with reference to various embodiments, it is understood that the words, which have been used herein, are words of description and illustration, rather than words of limitations. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

We claim:

1. A method of providing a response to a request for information from a user, comprising the steps of:
calling an intelligent information delivery system by said user;
recording said information request as an audio file at said intelligent information delivery system;
processing said audio file by utilizing the intelligent information delivery system, comprising the steps of:
refining a structured text form of the audio file into an optimized search query;
inputting said optimized search query to retrieve search results comprising information of interest from a data server;
processing said search results into an agent readability enhanced and context specific output;
displaying said agent readability enhanced and context specific output to an agent;
selecting context specific results from said displayed output by said agent;
formatting said selected context specific results to an optimized speech deliverable text form; and
communicating content of said optimized speech deliverable text form to the user.

2. The method of claim 1, wherein said step of communicating said content of the optimized speech deliverable text form to the user comprises a step of converting the optimized speech deliverable text form to a voice stream by the intelligent information delivery system and transmitting said voice stream to the user.

3. The method of claim 1, further comprising a step of maintaining and managing a voice connection between the intelligent information delivery system and the user.

4. The method of claim 1, wherein said step of processing the audio file further comprises a step of playing the audio file by the agent and transcribing said played audio file into said structured text form.

5. The method of claim 1, wherein said step of refining said structured text form comprises obtaining correct spelling and synonyms of keywords, grouping of said synonyms to form phrases specific to context of the information request of the user.

6. The method of claim 1, wherein said step of refining said structured text form comprises employing context specific prompts to provide the optimized search query.

7. The method of claim 6, wherein said step of employing said context specific prompts comprises storing the context specific prompts in an information database and constantly updating the context specific prompts.

8. The method of claim 1, wherein said step of refining said structured text form comprises an auto complete logic for automatically listing out words based on a first few letters typed by the agent, wherein the agent selects a word from said listed words.

9. The method of claim 1, wherein said step of processing the search results comprises an intelligent automated selection of text portions from the search results, wherein said selected text portions are specific to context of the information request of the user.

10. The method of claim 9, wherein the step of processing the search results further comprises an intelligent automated sequencing of the selected text portions in decreasing order of relevance specific to the context of the information request of the user.

11. The method of claim 1, wherein said step of selecting said context specific results comprises ranking of the context specific results by the agent.

12. The method of claim 1, wherein said step of formatting the selected context specific results comprises converting the selected context specific results to the optimized speech deliverable text form by performing translations, forming complete sentences, and adding speech elements using a markup language.

13. A system for providing a response to a request for information from a user, comprising:
an intelligent information delivery system for processing said information request of said user and providing an interface between the user and an agent, wherein said intelligent information delivery system comprises:
an information database;
a voice capturing tool for recording the information request as an audio file, wherein said voice capturing tool stores said audio file in said information database;
a computer aided speech automaton for generating voice prompts to maintain and manage a voice connection between the intelligent information delivery system and the user, wherein said voice connection enables the user to make the information request;
an optimized search query generator for generating an optimized search query from a structured text form of the audio file, wherein said structured text form is a structured transcription of the audio file;
a context specific result display engine for displaying search results retrieved from a data server based on said optimized search query, wherein said search results are displayed as an agent readability enhanced and context specific output;
a search result ranking tool for ranking context specific results selected by said agent from said displayed output; and
a text to phoneme conversion engine for formatting said selected context specific results to an optimized speech deliverable text form.

14. The system of claim 13, wherein said optimized search query generator is a programmed tool for dynamically loading valid keywords for retrieving the search results, further wherein the optimized query generator comprises a keyword processing engine incorporated with auto complete logic.

15. The system of claim 13, wherein the information database comprises a dynamic table comprising synonyms, grouped words, phraseology, voice prompts, and context specific prompts.

16. The system of claim 13, wherein the intelligent information delivery system further comprises a speech synthesizer for converting the optimized speech deliverable text form to a voice stream.

17. A computer program product comprising computer executable instructions embodied in a computer-readable medium, said computer program product comprising:
a first computer parsable program code for recording an information request of a user as an audio file at an intelligent information delivery system;
a second computer parsable program code for processing the audio file, further comprising:
a third computer parsable program code for refining a structured text form of the audio file into an optimized search query;
a fourth computer parsable program code for processing search results retrieved from a data server based on said optimized search query into an agent readability enhanced and context specific output;
a fifth computer parsable program code for displaying said agent readability enhanced and context specific output to said agent;
a sixth computer parsable program code for selecting context specific results from said displayed output;
a seventh computer parsable program code for formatting said selected context specific results to an optimized speech deliverable text form;
an eighth computer parsable program code for providing said optimized speech deliverable text form to said intelligent information delivery system; and
a ninth computer parsable program code for communicating content of the optimized speech deliverable text form to the user.

18. The computer program product of claim 17, further comprising a tenth computer parsable program code for converting the optimized speech deliverable text form to a voice stream and transmitting said voice stream to the user.

19. The computer program product of claim 17, further comprising an eleventh computer parsable program code for maintaining and managing a voice connection between the intelligent information delivery system and the user.

20. The computer program product of claim 17, further comprising a twelfth computer parsable program code for obtaining correct spelling and synonyms of keywords and grouping of said synonyms to form phrases specific to context of the information request of the user.

21. The computer program product of claim 17, further comprising a thirteenth computer parsable program code for employing context specific prompts to provide the optimized search query.

22. The computer program product of claim 21, further comprising a fourteenth computer parsable program code for storing said context specific prompts in an information database and constantly updating the context specific prompts.

23. The computer program product of claim 17, further comprising a fifteenth computer parsable program code for an intelligent automated sequencing of selected text portions from said search results in decreasing order of relevance specific to the context of the information request of the user.

24. The computer program product of claim 17, further comprising a sixteenth computer parsable program code for ranking the selected context specific results.

25. The computer program product of claim 17, further comprising a seventeenth computer parsable program code for converting the selected context specific results to the optimized speech deliverable text form by performing translations, forming complete sentences, and adding speech elements using a markup language.
